(19) United States
(12) Patent Application Publication
(10) Pub. No.: US 2017/0046540 A1
(43) Pub. Date: Feb. 16, 2017

(54) AUTHENTICATION OF DETACHABLE PERIPHERAL DEVICES

(71) Applicant: CIRQUE CORPORATION, Salt Lake City, UT (US)

(72) Inventor: Jared G. Bytheway, Sandy, UT (US)

(21) Appl. No.: 15/233,081

(22) Filed: Aug. 10, 2016

Related U.S. Application Data
(60) Provisional application No. 62/203,634, filed on Aug. 11, 2015.

(51) Int. Cl. G06F 21/82; G06F 1/32

(52) U.S. Cl. CPC G06F 21/82; G06F 1/3296; G06F 2221/2129

(57) ABSTRACT

A system and method for enabling an electronic appliance to verify the authenticity of a detachable peripheral device before that peripheral device is used by measuring a controlled impedance of a common wire and returning a proportional value, wherein the host may change or modulate the impedance of the wire before or during each measurement that the peripheral device makes, and if the peripheral device's reported answer matches the expected answer of the host, then the host device may allow the peripheral device to function properly.

### BACKGROUND OF THE INVENTION

Field Of the Invention

This invention relates generally to electronic appliances that have detachable peripheral devices. Specifically, the invention pertains to a system and method for enabling an electronic appliance to verify the authenticity of a detachable peripheral device before that peripheral device is used, and thereby avoid potential problems that may occur when attaching a peripheral device that is not authorized to operate with a particular electronic appliance.

Description of the Prior Art

Numerous consumer and commercial electronic appliances have removable or add-on peripheral components. The peripheral components provide value, flexibility, and/or convenience to the user. For example, many peripheral devices are consumable and are intended to be replaced, such as ink or toner cartridges used in printers, where the ink and toner cartridges are the removable peripheral devices and the printer is the electronic appliance.

Other examples of electronic appliance and peripheral device combinations include but should not be considered as limited to devices with a rechargeable battery such as drills, laptop computers, mobile telephones, cameras, music playing devices, touch panels and replacement parts in white goods.

It should be understood that there are many other electronic appliances and many other removable peripheral devices that may fall within the scope of the present invention. Accordingly, it should be understood that the list above are only examples and the invention is not limited by the list.

To maintain high quality standards and to protect profits, manufactures want to eliminate the use of counterfeit or unauthorized peripheral devices. Furthermore, consumers don't want to buy low quality counterfeits that may damage the electronic appliance. Another problem that may occur is that peripheral devices may be illegally produced at the same factory as the original products, but the factory may sell the illegal peripheral devices through other channels without authorization.

One method that is used in the prior art to discourage the use of counterfeit peripheral devices may be to include an authentication integrated circuit (IC) chip in the peripheral devices. The electronic appliance must then authenticate the peripheral device by scanning for the presence of the authentication IC chip before allowing the peripheral device to function. Unfortunately, these authentication schemes may add significant cost to the electronic appliance and/or to the peripheral devices.

### BRIEF SUMMARY OF THE INVENTION

In a first embodiment, the present invention is a system and method for enabling an electronic appliance to verify the authenticity of a peripheral device before that peripheral device is attached to the electronic appliance. The peripheral device may be a new device that is attached in order to provide additional functionality to the electronic appliance such as a keyboard, mouse, touchpad, memory storage device, microphone, speaker, camera or web-camera. The peripheral device may also be a replaceable component such as a battery or toner cartridge. These examples should not be considered to be limiting but only as examples of possible peripheral devices.

Before the peripheral device is activated, for example, by using it or providing power to it, the peripheral device may be tested or verified. The testing or verification process may be accomplished by any convenient means. For example, the peripheral device might be tested by measuring a controlled impedance of a common wire, wherein the electronic appliance may change or modulate the impedance of the wire before or during each measurement of the peripheral device. If the peripheral device's reported impedance measurement matches the expected response of the electronic appliance, then the invention may allow the peripheral device and the electronic appliance to function together.

In another aspect of the invention, if the peripheral device's reported response didn't match the expected response, then the electronic appliance may take an action that prevents the peripheral device from functioning. For example, the electronic appliance may disable the peripheral device, it may display a notice of incompatibility, it may allow limited functionality, or it may allow full functionality for a limited amount of time. These examples should not be considered as limiting of all the possible responses by the electronic appliance.

These and other objects, features, advantages and alternative aspects of the present invention will become apparent to those skilled in the art from a consideration of the following detailed description taken in combination with the accompanying drawings.

### BRIEF DESCRIPTION OF THE SEVERAL VIEWS OF THE DRAWINGS

FIG. 1 is a block diagram of a system that may implement the embodiments of the invention.

FIG. 2 is a block diagram of operation of a touch sensor that is found in the prior art, and which is adaptable for use in the present invention.

### DETAILED DESCRIPTION OF THE INVENTION

Reference will now be made to the drawings in which the various elements of the present invention will be given numerical designations and in which the invention will be discussed so as to enable one skilled in the art to make and use the invention. It is to be understood that the following description is only exemplary of the principles of the present invention, and should not be viewed as narrowing the claims which follow.

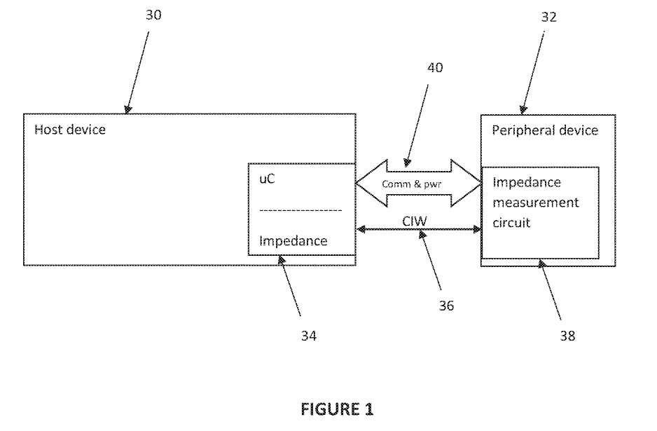

FIG. 1 is a block diagram showing a first embodiment of the invention. In this first embodiment there is an electronic appliance that may also be referred to interchangeably as a host device 30. A peripheral device 32 is also shown that may be connected externally or internally to the host device 30. Thus, the peripheral device 32 may be an external device that is coupled by an electrical connector such as a USB cable or a lightning cable to the host device 30. Alternatively, the peripheral device 32 may be an internal device such us a battery or a toner cartridge. None of the examples of the peripheral devices 12 should be considered to be limiting regarding the nature or function of the peripheral devices.

A first embodiment of an authentication system may be comprised of a circuit within the host device 30 and the peripheral device 32. The authentication system may be any system that enables the host device 30 to authenticate the peripheral device 32. The authentication system may be part of any connection between the host device 30 and the peripheral device 32. The authentication system may be capable of interrupting or preventing communication between the host device 30 and the peripheral device 32.

One example of a specific authentication system of the first embodiment is shown in FIG. 1. FIG. 1 shows that the host device 30 may include a host custom integrated circuit 34 that toggles a controlled impedance wire 36 (CIW) through a variable capacitor network within the host custom integrated circuit, wherein the toggling is synchronous with a peripheral custom integrated circuit 38 that may be disposed in the peripheral device 32 that may perform an impedance measurement. The host device and the peripheral device 32 may communicate through a communication bus 40. The communication bus 40 may also include power from the host device 30 to the peripheral device 32.

The CIW 36 may also be a communication link between the host device 30 and the peripheral device 32.

The impedance of the CIW 36 may typically be caused to change by very small amounts by the host device 30. Such small impedance changes may only be detectable by the host custom integrated circuit 34 and the peripheral custom integrated circuit 38, or by very expensive counterfeit measurement systems. The impedance with respect to ground may also be measured and reported. The host custom integrated circuit 34 and the peripheral custom integrated circuit 38 may be inexpensive items when the authentication system uses a touch sensor circuit from Cirque Corporation.

In a typical scenario of the first embodiment, the peripheral device 32 may be attached to the host device 30 at some connector, wherein the connector is coupled to the communication bus 40. In this first embodiment, the host device 30 may test the authenticity of the peripheral device 32 before the function or functions of the peripheral device is used by the host device.

The authentication system used by the host device 30 and the peripheral device 32 may then perform the operations necessary for an impedance measurement to be made using the host custom integrated circuit 34 and the peripheral custom integrated circuit 38 that enables the host device to authenticate the peripheral device.

In another embodiment, the two-way communication link of the communication bus 40 may be on the same wire as power to thereby minimize the number of conductors between the host device 30 and the peripheral device 32.

In another embodiment, the CIW 36 may also function as the power wire where the power, communication, and impedance measurements are all on the same wire and may be all simultaneous functions, sequential functions, or combinations of sequential and simultaneous functions but at different times.

In another embodiment, the peripheral impedance measuring circuit 18 may regulate the voltage on the CIW 36 such that the host device 30 may detect that the peripheral device 32 is using a regulated analog front end. However, such front ends may be more difficult to build.

In another embodiment, the host device 30 and peripheral device 32 may each perform multiple impedance measurements where one or both of the host device 30 and the peripheral device 32 change the impedance of the CIW 36.

In another embodiment, the host device 30 may perform impedance measurements on the CIW 36 with expectations of certain impedances when the peripheral device 32 is disabled versus when it's enabled and configured with certain output impedances. This embodiment may also be capable of detecting snooping devices that may be connected to the CIW 36.

In another embodiment, the host or peripheral impedance measurement circuits 14, 18 may dynamically change the voltage in a random pattern which the host device 30 may recognize, while a counterfeit circuit would have difficulty duplicating the same precise voltage changes.

In another embodiment, there are two CIWs 16 that connect the peripheral device 32 to the host device 30, where one of the devices 10, 12 initiates a measurement (the “initiator”) where one CIW 36 has a transmit signal disposed on it and the other CIW 36 has a receive signal on it. The receiving device (the “receiver”) changes the impedance between the transmit CIW and the receive CIW and between ground. The initiator sends the answer to the receiver where the receiver compares the answer to what it expected based on how it changed the impedance.

In another embodiment, the peripheral device 32 may include an impedance integrated circuit or the peripheral impedance measurement circuits 18 may include a number of resistors, capacitors, inductors and diodes connected in such a way that it would be very difficult to reproduce. The host device 30 would then perform one or more impedance measurements on the impedance integrated circuit that is connected with the CIW 36.

Typically the impedance integrated circuit would not be powered and may only have two ports. The host device 30 may perform any number of random type measurements on a particular part of the impedance integrated circuit. For example, the DC voltage may be raised to put a diode in the impedance integrated circuit in a different operating region. Another example may be to change the frequency where a certain part of the impedance integrated circuit would have a different impedance.

The embodiments of the invention may include the host or peripheral impedance measurement circuits 14, 18 having a very sensitive impedance measurement capability and the amount of impedance changes would be very small, on the order of a few femtofarads.

A circuit that may be adapted for use in the embodiments of the invention may be a capacitance sensing circuit used in touch sensors. The host custom integrated circuit 34 and the peripheral custom integrated circuit 38 that enables the host device to authenticate the peripheral device may use capacitance or voltage as a system of authentication. It is useful to examine the underlying technology of the touch sensors to better understand how any capacitance sensitive touch sensor may be used in the present invention.

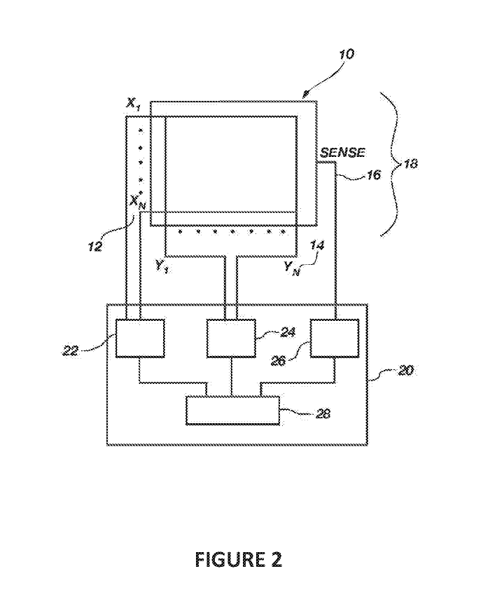

The CIRQUE® Corporation touch sensor is a mutual capacitance-sensing device and an example is illustrated as a block diagram in FIG. 2. In this touchpad 10, a grid of X (12) and Y (14) electrodes and a sense electrode 16 is used to define the touch-sensitive area 18 of the touchpad. Typically, the touchpad 10 is a rectangular grid of approximately 16 by 12 electrodes, or 8 by 6 electrodes when there are space constraints. Interlaced with these X (12) and Y (14) (or row and column) electrodes is a single sense electrode 16. All position measurements are made through the sense electrode 16.

The CIRQUE® Corporation touchpad 10 measures an imbalance in electrical charge on the sense line 16. When no pointing object is on or in proximity to the touchpad 10, the touchpad circuitry 20 is in a balanced state, and there is no charge imbalance on the sense line 16. When a pointing object creates imbalance because of capacitive coupling when the object approaches or touches a touch surface (the sensing area 18 of the touchpad 10), a change in capacitance occurs on the electrodes 12, 14. What is measured is the change in capacitance, but not the absolute capacitance value on the electrodes 12, 14. The touchpad 10 determines the change in capacitance by measuring the amount of charge that must be injected onto the sense line 16 to reestablish or regain balance of charge on the sense line.

The system above is utilized to determine the position of a finger on or in proximity to a touchpad 10 as follows. This example describes row electrodes 12, and is repeated in the same manner for the column electrodes 14. The values obtained from the row and column electrode measurements determine an intersection which is the centroid of the pointing object on or in proximity to the touchpad 10.

In the first step, a first set of row electrodes 12 are driven with a first signal from P, N generator 22, and a different but adjacent second set of row electrodes are driven with a second signal from the P, N generator. The touchpad circuitry 20 obtains a value from the sense line 16 using a mutual capacitance measuring device 26 that indicates which row electrode is closest to the pointing object. However, the touchpad circuitry 20 under the control of some microcontroller 28 cannot yet determine on which side of the row electrode the pointing object is located, nor can the touchpad circuitry 20 determine just how far the pointing object is located away from the electrode. Thus, the system shifts by one electrode the group of electrodes 12 to be driven. In other words, the electrode on one side of the group is added, while the electrode on the opposite side of the group is no longer driven. The new group is then driven by the P, N generator 22 and a second measurement of the sense line 16 is taken.

From these two measurements, it is possible to determine on which side of the row electrode the pointing object is located, and how far away. Using an equation that compares the magnitude of the two signals measured then performs pointing object position determination.

The sensitivity or resolution of the CIRQUE® Corporation touch sensor may be used to detect a signal between the host device 30 and the peripheral device 32. For example, the host device 30 may include a touch sensor circuit that is able to detect a precise capacitance or voltage generated by the peripheral device 32.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. It is the express intention of the applicant not to invoke 35 U.S.C. §112, paragraph 6 for any limitations of any of the claims herein, except for those in which the claim expressly uses the words ‘means for’ together with an associated function.

What is claimed is:

1. A method for enabling an electronic appliance to verify the authenticity of a detachable peripheral device before that peripheral device is used, said method comprising:
providing a host device having a host custom integrated circuit, a peripheral device having a peripheral custom integrated circuit, and a communication link disposed so as to enable communication between the host custom integrated circuit and the peripheral custom integrated circuit;
toggling the controlled impedance wire through a variable capacitor network within the host custom integrated circuit, wherein the toggling is synchronous with the peripheral custom integrated circuit;
making an impedance measurement of the communication link.

2. The method as defined in claim 1 wherein the method further comprises using a controlled impedance wire as the communication link.

3. The method as defined in claim 1 wherein the method further comprises authenticating the peripheral device by comparing the measured impedance against an expected impedance value.

4. The method as defined in claim 1 wherein the method further comprises:
providing a capacitive touch sensor circuit as the host custom integrated circuit and a voltage generating circuit as the peripheral custom integrated circuit;
generating one or more voltages from the peripheral custom integrated circuit on the communication link;
measuring voltages on the communication link using the host custom integrated circuit; and
comparing measured voltages on the communication link to at least one expected voltage, and enabling the peripheral device to function if the at least one expected voltage is found, and preventing operation of the peripheral device if the at least one expected voltage is not found.
